(19) United States
(12) Patent Application Publication
(10) Pub. No.: US 2026/0287036 A1
(43) Pub. Date: Sep. 24, 2026

(54) SHELL AND CAP FOR FRICTION SHOCK ABSORBER FOR WASHING MACHINES

(71) Applicant: C.I.M.A. SPA-COMPAGNIA ITALIANA MOLLE ACCIAIO, Busnago (MB) (IT)

(72) Inventor: Andrea Franco, Busnago (MB) (IT)

(73) Assignee: : C.I.M.A. SPA-COMPAGNIA ITALIANA MOLLE ACCIAIO, Busnago (MB) (IT)

(21) Appl. No.: 19/476,399

(22) PCT Filed: Jul. 3, 2023
(86) PCT No.: PCT/IB2023/056882

§ 371 Date: Oct. 17, 2025

(51) Int. Cl. F16F 7/09; D06F 37/22

(52) U.S. Cl. CPC F16F 7/09; D06F 37/22

(57) ABSTRACT

A friction shock absorber for washing machines, provided with optimized shell and closing cap. The absorber is provided with an horizontal axis of rotation, which overcomes the limits of the embodiments known at the state of the art, and which in particular has a cap which can be assembled to the shell without needing a precise angular positioning and relative rotation movements between cap and shell, in which the duration of lubrication of the relative sliding movement between piston and cap is guaranteed. In another embodiment, the shock absorber has a horizontal axis of rotation in which there are no inlet paths for water, in the coupling of cap and shell.

Object of the present invention is a friction shock absorber for washing machines, provided with optimized shell and closing cap.

### TECHNICAL FIELD

The use of shock absorbers in washing machines is known. They are devices fastened to the drum and frame of washing machines, useful to reduce noise and vibrations caused by centrifugation of electric washing machines.

All the known embodiments comprise: a shell (or outer casing) with substantially tubular shape, open to end, and a piston sliding inside said shell, shell and piston being fastened the one to the frame and the other one to the drum of a washing machine.

Furthermore, shock absorbers comprise one or more friction rings, interposed between the sliding piston and shell, and configured to dampen the alternating oscillation of the piston caused by the rotation of the drum of the washing machine with respect to the frame. According to the embodiments, these friction rings can be positioned inside cages sliding both to the piston and shell, mounted inside the shell but outside the piston, or they can be of stationary type, introduced in suitable housings obtained in the inner wall of the shell. Shock absorbers comprise also a cap with central through hole, provided at the open end of the shell in which the piston is introduced, to receive the friction ring, and which, sometimes, has also the function of piston guide and lubrication.

### State of the Art

At the state of the art, there are known various embodiments of friction shock absorbers for washing machines, basically working according to what just explained. EP1584730 describes a friction shock absorber for washing machines provided with closing cap with elastic tongues. A variant is described in EP1637640, in which it is described a shock absorber in which the cap comprises inner teeth acting as stops for the cage inside which the friction ring is provided. In EP3809010 it is described a shock absorber for washing machines in which cap and shell are assembled by means of axial movement upon positioning in a precise relative position to each other. A similar embodiment, meaning that it requires a precise positioning of the shell to the cap is described in DE202016102547. Slightly different cap embodiments from the just cited ones are described in EP1754908 and EP2406519.

US2017/292215 describes a friction shock absorber for washing machines, comprising a shell, a piston, a cap and a dampening element.

The cap shown in US2017/292215 (and referred for reading convenience in the appended FIG. 15) comprises a plurality of supporting blocks for the piston sliding, which have very limited axial extension with respect to the axial extension of the cap, and a tapered shape outwards of the cap. In other terms, the contact surface between supporting blocks and piston is subdivided in a small number of short and wide surfaces. This arrangement is not optimized for lubrication of coupling of piston and cap, since it does not allow, during operation, the grease to seal the free space between cap hole and piston.

Moreover, the just cited cap requires, in assembling step, a precise angular positioning to the shell, since it has a series of snap hooks which have to be assembled in respective holes provided on the shell.

Anyway, also the other embodiments known at the state of the art are limited, in all the cases in order to assemble the cap to the shell it is needed a precise angular positioning, or it is needed to use relative rotation movements between cap and shell. Furthermore, the duration of lubrication of relative sliding movement between piston and cap is not guaranteed.

However, in the embodiments known at the state of the art, slits/elongated holes are provided on the shell, which are useful to accommodate respective cap teeth (or vice versa slits are provided on the cap to accommodate respective teeth provided on the shell).

The provision of teeth on the shell and of corresponding holes on the cap, creates inlet paths for water, which is often generated by condensation at the shock absorbers, which can enter the housing of the friction stripe, thus soaking the friction stripe and varying its friction features, with consequent shock absorber functioning departing from the design conditions.

### Aim of the Invention

Therefore, aim of the present invention is to provide a shock absorber for washing machines with horizontal axis of rotation, which overcomes the limits of the embodiments known at the state of the art, and which in particular has a cap which can be assembled to the shell without needing a precise angular positioning and relative rotation movements between cap and shell, in which the duration of lubrication of the relative sliding movement between piston and cap is guaranteed.

According to another aim, the present invention provides a shock absorber for washing machines with horizontal axis of rotation in which there are no inlet paths for water, in the coupling of cap and shell.

### Brief Description

The invention realizes the prefixed aims since it is a shock absorber for washing machines with horizontal axis of rotation, comprising a shell (2) inside which a piston (3) slides, a friction ring (5) positioned around said piston (3) inside said shell and configured to exert a friction action on said piston upon a relative movement between piston and shell, and a cap (4), said cap (4) being provided with a central through hole (46) inside which said piston (3) is introduced, characterized in that the inner surface of said through hole (46) comprises a plurality of longitudinal grooves (41), among which ribs (43) are interposed, said ribs (43) having a tapered profile from outside towards the center, said shell (2) comprises a first portion (21), hollow inside, in which said cap (4) is housed by means of axial introduction, and a second portion (22) in which the piston (3) slides, and in that said first hollow section (21) is provided with a plurality of circumferential grooves (211) and said cap (4) comprises an abutting surface (44) configured to abut a respective abutting surface (25) of the shell (2) and a portion (45) configured to be introduced in the first portion (21), hollow inside, of said shell (2).

### DETAILED DESCRIPTION

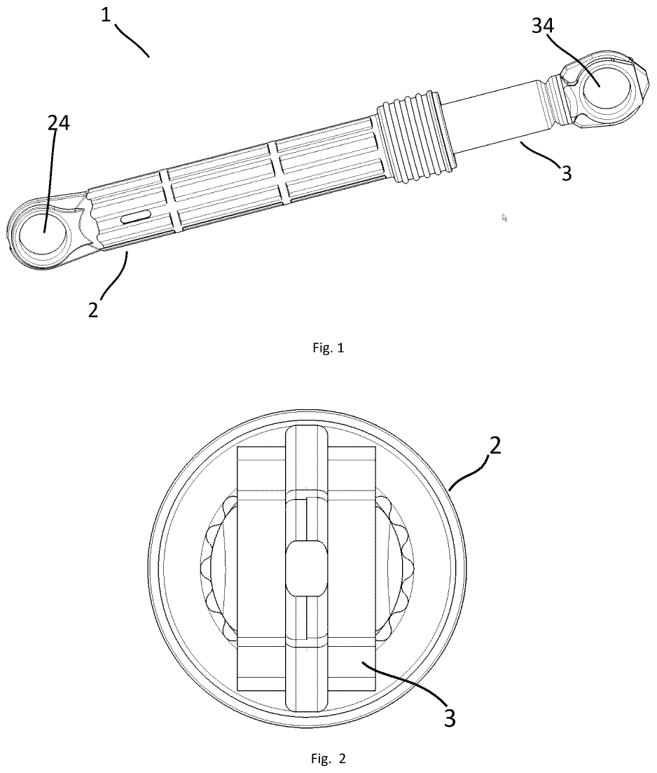

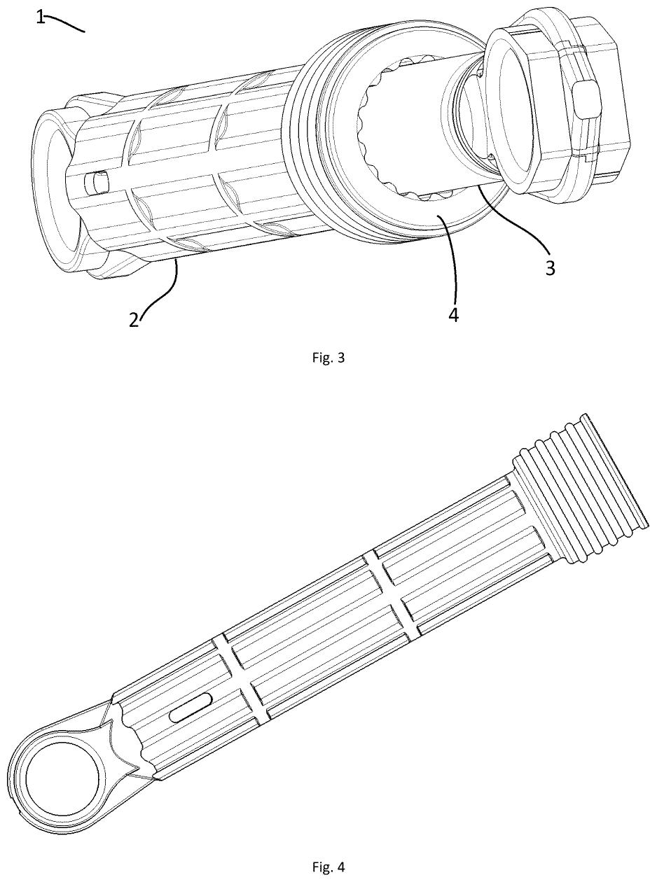

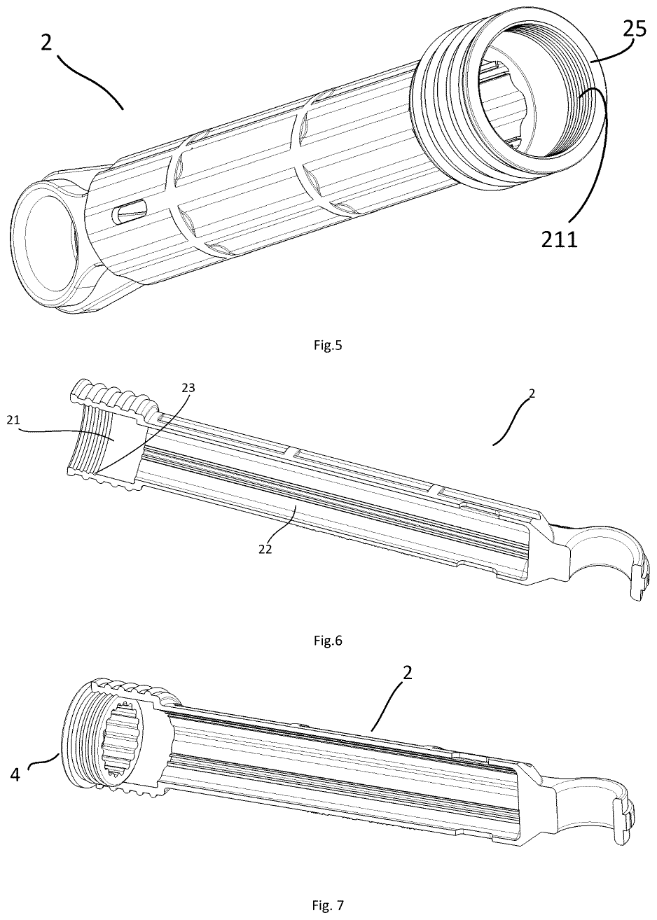

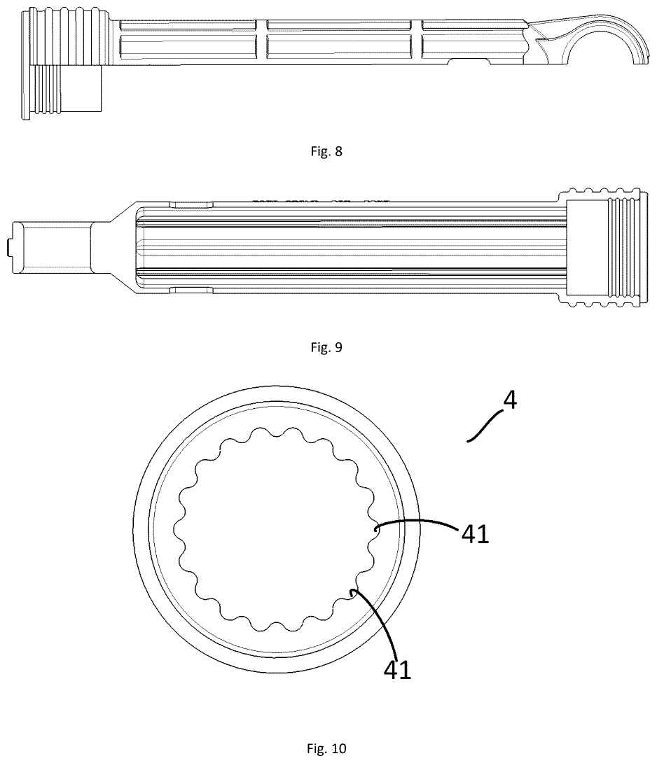

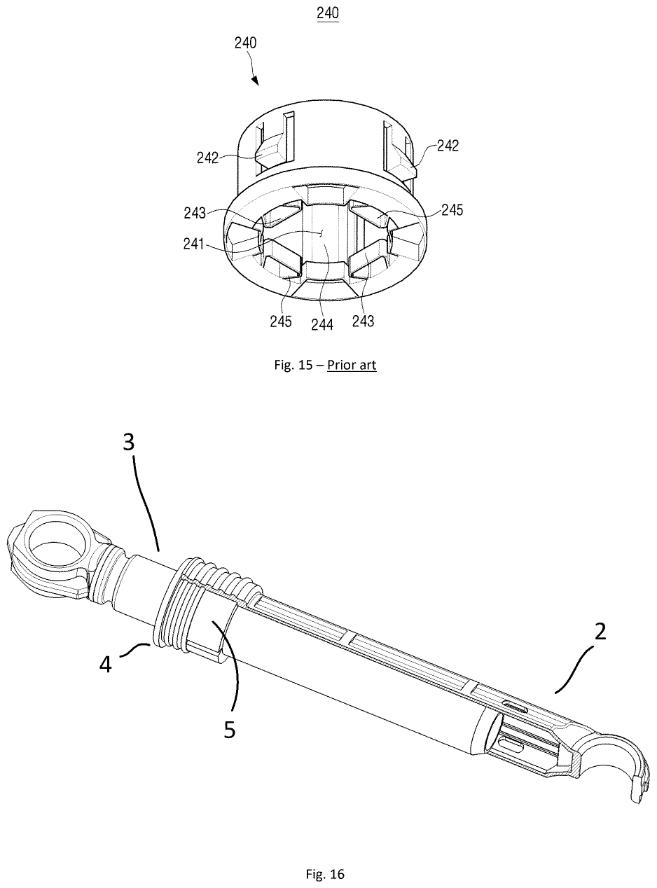

A detailed description of some preferred embodiments of the invention will be carried out in the following, with reference to the appended FIGS. 1 to 14.

FIGS. 1 to 3 show three assembled views of a preferred embodiment of the shock absorber according to the present invention;

FIGS. 4 to 9 show various views of the shell to be used with the shock absorber according to the invention;

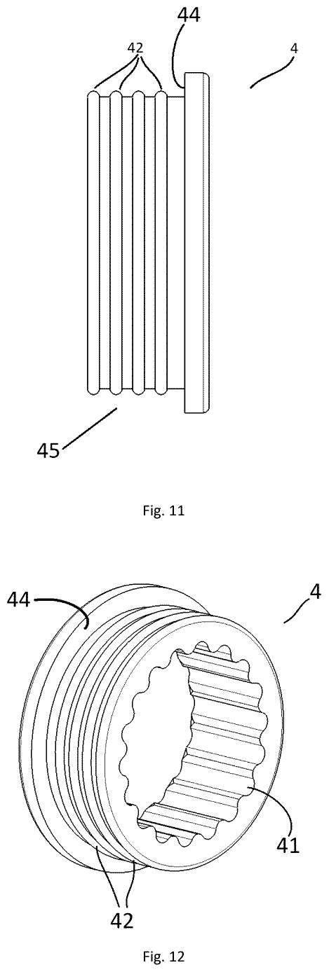

FIGS. 10 to 14 show various views of the cap to be used with the shock absorber according to the invention.

As it is shown in FIG. 1, the device (1) comprises a shell (2), inside which a piston (3) slides.

Both the shell (2) and piston (3) are provided with fastening rings (24, 34) for fastening to the frame and drum of a washing machine, in particular for fastening to a washing machine with horizontal axis of rotation.

As it is shown in FIG. 6, the shell (2) according to the invention comprises a first portion (21), hollow inside, in which the cap (4) is housed by means of axial introduction, and a second portion (22) in which the piston (3) slides.

In particular, the first hollow section (21) is provided with a plurality of circumferential grooves (211).

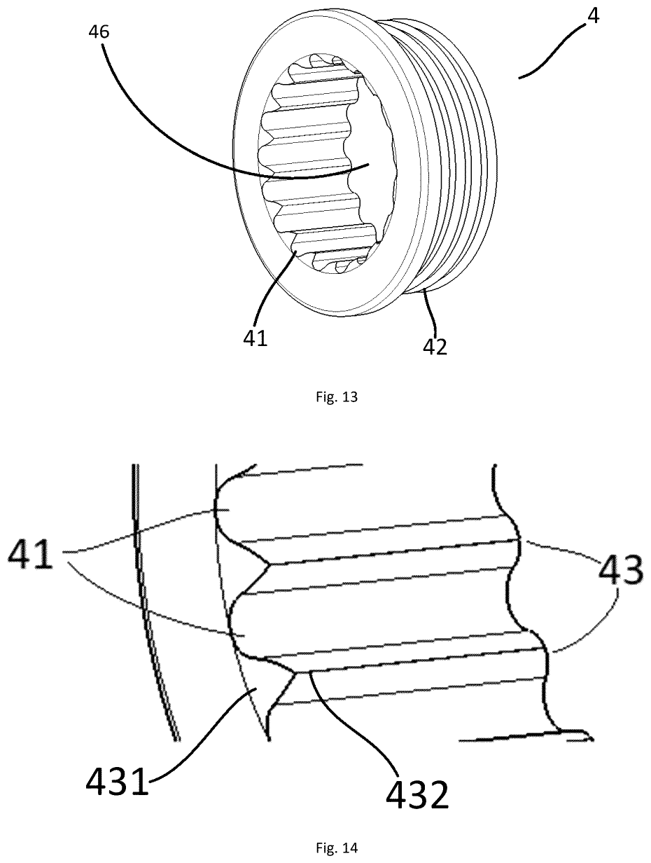

FIGS. 11 and 12 show a cap (4) provided with: an abutting surface (44) configured to abut the respective abutting surface (25) of the shell (2), and provided with a portion (45) configured to be introduced in the first portion (21), hollow inside, of the shell (2).

In particular, the portion (45) of the cap (4) configured to be introduced inside the shell (2) comprises a plurality of circumferential ribs (42). These circumferential ribs are configured for interference fit with the respective circumferential grooves (211) of the shell (2).

In this way, once the cap (4) is introduced axially in the shell (2), up to be in abutment with its own surface (44), it will not be able to come out from its own seat anymore.

This coupling of shell (2) and cap (4) is the first feature of the device (1) according to the invention which makes it better than the devices known at the state of the art; in fact, for the assembly of the cap (4) it is not needed to follow any angular reference. The cap (4), in its outer geometry, is completely symmetrical around its own axis, and so, it will be able to be assembled correctly regardless of its own rotation angle and by means of only an axial movement (it is not needed any relative rotation in assembly step between cap and shell).

This is clearly an extremely advantageous condition while organizing automatized production lines both for devices needing the cap to be screwed on the shell (and so needing a relative rotation movement) and for devices needing a good determined angular position of the cap to the shell for the assembly.

The cap (4) comprises also a central through hole (46) inside with the piston (3) can be introduced. The inner surface of such through hole (46) is provided with a plurality of longitudinal grooves (41), among which ribs (43) are interposed.

The ribs (43) extend along the whole axial extension of the cap.

Preferably, the ribs (43) are in number greater than 12, and more preferably in number 18 to 20.

The grooves (41) have a reduced radial depth in comparison to the dimensions of the cap, with radius difference between valley of groove (41) and head of rib (43) preferably equal to about 1/20 the diameter of the central hole of the cap (4).

The function of this alternation of grooves and ribs is to optimize lubrication of the piston (3) while sliding.

It is observed in fact that the piston (3) slides inside the central hole of the cap, guided by the friction ring (5) in polyurethane. So, the device does not rely on the contact action between piston and ribs to guide the piston movement. The contact between piston and ribs is occasional, linked to the presence of temporary vibrations or stresses, and, however, it is lubricated by the grease introduced in assembly step, which is deposited in the longitudinal grooves (41) and generates a lubricating veil also on the crest of the ribs (43). As it is shown for example in FIG. 14, the ribs (43) have a tapered profile from outside towards the center. The base (431) of the rib (43) is larger than the head (432) of the rib, and the section of the rib is such that there are no gaps under the rib itself.

So, the grease is never under the rib, and is completely available to improve lubrication.

Moreover, the fact that the ribs are in great number and that the grooves have a limited depth allows the grease introduced in lubricating step to seal substantially the free space between cap and piston, avoiding that dirty and humidity penetrate inside the shell.

In operation step, the relative movement between piston (3) and shell (2), and the vibrations, the device (1) is inevitably subjected to, cause the grease accumulated in the longitudinal grooves to be distributed in substantially uniform way on the surface of the piston.

Practically, the grooves act as distributed tanks of lubricant.

It is observed that with the shown embodiment, it is not needed the provision of elongated holes for snap hooks coupling, and the cap closing on the shell is hermetic. So, there is no possibility that water enters the shell, thus ruining the friction ring and damaging the lubricating grease performance.

This fact prolongs remarkably the life of the device according to the invention in comparison to what known at the state of the art.

1. A shock absorber for washing machines with horizontal axis of rotation, comprising a shell (2) inside which a piston (3) slides, a friction ring (5) positioned around said piston (3) inside said shell and configured to exert a friction action on said piston upon a relative movement between piston and shell, and a cap (4), said cap (4) being provided with a central through hole (46) inside which said piston (3) is introduced,
and wherein:
the inner surface of said through hole (46) comprises a plurality of longitudinal grooves (41), among which ribs (43) are interposed, said ribs (43) having a tapered profile from outside towards the center,
said shell (2) comprises a first portion (21), hollow inside, in which said cap (4) is housed by means of axial introduction, and a second portion (22) in which the piston (3) slides,
and in that
said first hollow section (21) is provided with a plurality of circumferential grooves (211) and said cap (4) comprises an abutting surface (44) configured to abut a respective abutting surface (25) of the shell (2) and a portion (45) configured to be introduced in the first portion (21), hollow inside, of said shell (2) and provided with a plurality of circumferential ribs (42) configured to be coupled to said circumferential grooves (211).

2. The shock absorber for washing machines with horizontal axis of rotation according to claim 1, wherein said ribs (43) extend along the whole axial extension of the cap.

3. The shock absorber for washing machines with horizontal axis of rotation according to claim 1, wherein said ribs (43) are in number greater than 12.

4. The shock absorber for washing machines with horizontal axis of rotation according to claim 3, wherein said ribs (43) are in number 18 to 20.

5. The shock absorber for washing machines with horizontal axis of rotation according to claim 1, wherein a radius difference between valley of groove (41) and head of rib (43) is between 2,5 to 10% the diameter of the central hole of the cap (4).

6. The shock absorber for washing machines with horizontal axis of rotation according to claim 5, wherein the radius difference between valley of groove (41) and head of rib (43) is equal to about 1/20 the diameter of the central hole of the cap (4).

7. The shock absorber for washing machines with horizontal axis of rotation according to claim 1, wherein said ribs (43) have a tapered profile from outside towards the center, with the base (431) of the rib (43) having greater dimensions than the head (432) of the rib, and in that the section of the rib (43) has such a shape that there are no gaps arranged under the rib itself.

8. The shock absorber for washing machines with horizontal axis of rotation according to claim 1, wherein said portion (45) of the cap (4) configured to be introduced inside the shell (2) comprises a plurality of circumferential ribs (42).

9. The shock absorber for washing machines with horizontal axis of rotation according to claim 8, wherein said circumferential ribs (42) are configured to interference fit the respective circumferential grooves (211) provided on the inner surface of a first portion (21), hollow inside, of said shell (2), such that once said cap (4) is introduced axially in the shell (2), up to abut its own surface (44), it cannot come out from its seat anymore.

10. The shock absorber for washing machines with horizontal axis of rotation according to claim 1, wherein said shell (2) and said piston (3) are provided with fastening rings (24, 34) for fastening to the frame and drum of a washing machine.
